(19) United States
(12) Patent Application Publication
(10) Pub. No.: US 2025/0315473 A1
(43) Pub. Date: Oct. 9, 2025

(54) SYSTEM AND METHOD FOR GPU PROCESSING

(71) Applicant: ROYAL BANK OF CANADA, Toronto (CA)

(72) Inventors: Robert Arthur Lucian RACZKOWSKI, Fonthill (CA); Hisham ABU-ABED, Mississauga (CA); Rex DAVIS, Prior Lake, MN (US)

(21) Appl. No.: 19/170,492

(22) Filed: Apr. 4, 2025

Related U.S. Application Data
(60) Provisional application No. 63/575,442, filed on Apr. 5, 2024.

(51) Int. Cl. G06F 16/532; G06T 11/00

(52) U.S. Cl. CPC G06F 16/532; G06T 11/001

(57) ABSTRACT

There is provided a system and method for sprite-based Graphics Processing Unit (GPU) processing of structured data records. One or more structured databases may include one or more data records, each of said data records having one or more attributes having values. In response to receiving a query for the databases, for each data record, an image map comprising one or more pixels may be generated. The colour of each respective pixel may correspond to a value of each respective attribute for that data record. A plurality of image maps may be processed by a GPU to determine a response to the query. The result of the query may be displayed on a dashboard.

### CROSS-REFERENCE TO RELATED APPLICATIONS

This claims priority to, and the benefit of, U.S. Provisional Application No. 63/575,442, filed Apr. 5, 2024, the entire contents of which are incorporated herein by reference.

### FIELD

This relates generally to computer processing systems, and in particular to leveraging the use of Graphical Processing Units (GPUs) in structured data processing.

### BACKGROUND

Modern computing systems have evolved to include several different types of processing devices, including but not limited to controllers, microcontrollers, Field-Programmable Gate Arrays (FPGAs), Digital Signal Processors (DSPs), Central Processing Units (CPUs), Graphics Processing Units (GPUs), Physics Processing Units (PPUs), and the like. Different types of processors may be particularly suitable and/or efficient for certain types of calculations and/or processing.

The collection of data in all aspects of modern life is accelerating, particularly in view of the Internet of Things (IoT), and the resulting data may have numerous dimensions. The processing power required to process and analyze multi-dimensional data represents a significant challenge, both from a processing perspective and from an energy-consumption perspective.

There is a need to improve the processing efficiency of various complex and/or multidimensional computing tasks.

### SUMMARY

According to an aspect, there is provided a method of performing Graphics Processing Unit (GPU) based operations on structured data, the method comprising: accessing at least one database having a plurality of data records, each of said records having a plurality of attributes, each of said attributes having a value; for each of said data records, determining a respective colour corresponding to a respective value of at least one of said attributes; generating, for each of said data records, image data comprising at least one pixel having said respective colour corresponding to said at least one of said attributes; transmitting said image data to a graphics processing unit; executing a query on said image data; and transmitting a result of said query to a computing device.

According to another aspect, there is provided a system for performing Graphics Processing Unit (GPU) based operations on structured data, the system comprising: one or more processors; one or more GPUs; one or more non-transitory computer-readable storage media having stored thereon computer-executable instructions that, when executed by the one or more processors, cause the one or more processors to: access at least one database having a plurality of data records, each of said records having a plurality of attributes, each of said attributes having a value; for each of said data records, determine a respective colour corresponding to a respective value of at least one of said attributes; generate, for each of said data records, image data comprising at least one pixel having said respective colour corresponding to said at least one of said attributes; transmitting said image data to one or more of said GPUs; executing a query on said image data using said one or more GPUs; and transmitting a result of said query to a computing device.

Other features will become apparent from the drawings in conjunction with the following description.

### BRIEF DESCRIPTION OF DRAWINGS

In the figures which illustrate example embodiments,

FIG. 1 is a block diagram depicting components of an example computing system;

FIG. 2 is a block diagram depicting components of an example server or client computing device;

FIG. 3 depicts a simplified arrangement of software at a server or client computing device;

FIG. 4A is a flow diagram depicting a conventional database processing paradigm;

FIG. 4B is a flow diagram depicting a novel processing paradigm 450, in accordance with some embodiments;

FIG. 5A is a depiction of a database of structured data records;

FIG. 5B is a depiction of the database of FIG. 5A supplemented with colours mapped for certain attributes and a corresponding image for a data record;

FIG. 5C is a depiction of an array of pixels corresponding to a plurality of data records from the database of FIG. 5A;

FIG. 6 is a depiction of a process of querying a plurality of separate databases using CPU-based architectures;

FIG. 7 is a depiction of a process of querying a plurality of separate databases using data transformations for GPU-based architectures;

FIG. 8 is a flow chart depicting simplified process for determining a unique count of clients using data transformation and a GPU architecture;

FIG. 9 is a depicting of a two-dimensional array of pixels representing attributes of a structured data record; and

FIG. 10 is an example graphical user interface of a dashboard application configured to perform data analytics.

### DETAILED DESCRIPTION

A central processing unit (or CPU) is a computing hardware component that is the core computational unit in most computing devices, such as severs. CPUs typically handle most types of computing tasks required for an operating system and applications to run. GPUs are a distinct type of processing unit which are specialized to as to handle certain types of complex mathematical operations that run in parallel more efficiently than a general purpose CPU. For example, GPUs are typically used to process computer graphics and images very quickly and efficiently relative to a CPU performing the same task, in part due to the GPU using parallel processing capabilities which are inherent to graphics chip architectures. GPUs were initially created to more efficiently handle graphics rendering tasks in gaming and animation, although the use of GPUs is not necessarily limited to graphics processing.

Some embodiments relate to more efficient and innovative techniques for processing certain types of structured data (e.g. business records and transaction records) by encoding the structured data as image data. In so doing, this image data would then be in a format which GPUs are designed to efficiently process, taking better or full advantage of the parallel processing capabilities of a GPU.

In some embodiments, the conversion of structured data records to image data may provide numerous benefits, including simplifying the process for the end user, lowering processing costs, and allowing for the analysis of larger volumes of data. Moreover, in some embodiments, applications which require real-time processing of data for visualization purposes may be implemented using less expensive/powerful computing hardware than has been typically required (e.g., Tableau or PowerBI in-memory processing engines).

Some embodiments may relate to using GPU hardware instead of CPU hardware, or using a combination of GPU and CPU hardware, to process types of data which are not conventionally suitable for processing by GPU hardware. For example, GPU hardware may be capable of more efficient and/or accelerated processing of tasks involving parallel processing, such as artificial intelligence (AI), machine learning (ML), and other tasks. For example, each GPU on a commercially available Nvidia H100 may include 80 Tensor cores and 2,304 CUDA processing cores, compared to 64 processing cores on a CPU. Thus, it may be advantageous to condition and/or transform data into structures and/or formats which are more conducive to the unconventional use of GPU hardware, rather than requiring the use of more expensive, computationally-intensive, and resource-intensive CPU hardware architectures.

There may be situations in which billions of data records (e.g. customer and transaction data) are required to be processed. This may be the case, for example, if historical customer and transaction data is being used for analysis and/or training machine learning models. The use of CPU architectures for such processing is very time-intensive, cost-intensive, and energy-intensive. In some embodiments, encoding or otherwise converting portions of, or all of, the data records into image data may allow for such processing tasks to be completed in one or more of: less time, with less energy consumption, and/or at a lower cost.

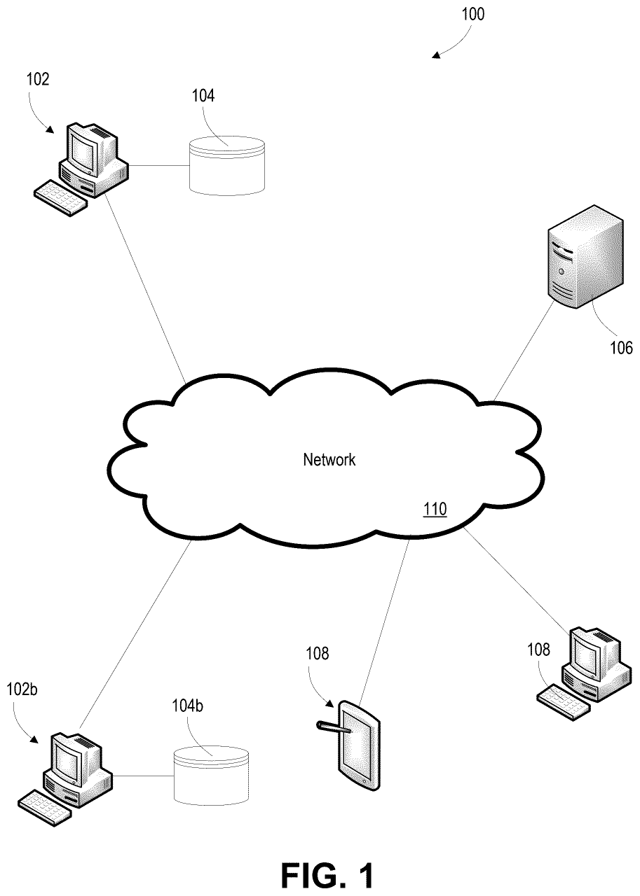

Various embodiments of the present invention may make use of interconnected computer networks and components. FIG. 1 is a block diagram depicting components of an example computing system 100. As used herein, the term “computing system” refers to a combination of hardware devices configured under control of software and interconnections between such devices and software. Such systems may be operated by one or more users or operated autonomously or semi-autonomously once initialized.

As depicted, system 100 includes at least one server 102 with a data storage 104 such as a hard drive, an array of hard drives, network-accessible storage, or the like; at least one web server 106, and a plurality of client computing devices 108. It is contemplated that client computing devices 108 may include numerous devices configured to generate and/or transmit data, including but not limited to connected vehicles, smart appliances, payment terminals, mobile kiosks, and the like. Server 102, web server 106, and client computing devices 108 are in communication by way of a network 110. More or fewer of each component are contemplated relative to the example configuration depicted in FIG. 1.

Network 110 may include one or more local-area networks or wide-area networks, such as IPv4, IPV6, X.25, IPX compliant, or similar networks, including one or more wired or wireless access points. The networks may include one or more local-area networks (LANs) or wide-area networks (WANs), such as the internet. In some embodiments, the networks are connected with other communications networks, such as GSM/GPRS/3G/4G/LTE/5G networks.

As shown, server 102 and web server 106 are separate machines, which may be at different physical or geographical locations. However, server 102 and web server 106 may alternatively be implemented in a single physical device.

As will be described in further detail, server 102 may be connected to a data storage 104. In some embodiments, web server 106 hosts a website accessible by client computing devices 108. Web server 106 is further operable to exchange data with server 102 such that data associated with various client computing devices 108 can be retrieved from server 102 and utilized in connection with various computing tasks.

Server 102 and web server 106 may be based on Microsoft Windows, Linux, or other suitable operating systems. Client computing devices 108 may be, for example, personal computers, smartphones, tablet computers, connected and/or autonomous vehicle, point of sale terminals, automated teller machines, or the like, and may be based on any suitable operating system, such as Microsoft Windows, Apple OS X or iOS, Linux, Android, or the like.

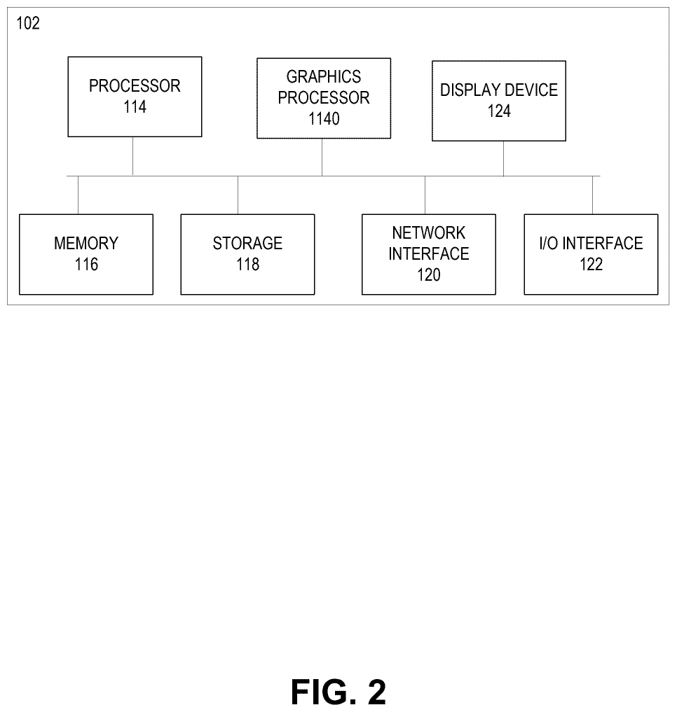

FIG. 2 is a block diagram depicting components of an example server 102, 106, or client computing device 108. As depicted, each server 102, 106, client device 108, may include a processor 114, memory 116, persistent storage 118, network interface 120, graphics processor (GPU) 1140, display device 124, and input/output interface 122.

Processor 114 may be an Intel or AMD x86 or x64, PowerPC, ARM processor, or the like, commonly referred to as a Central Processing Unit (CPU). In some embodiments, processor 114 may have multiple processing cores. For example, an Intel XEON server CPU may have 64 processing cores. Processor 114 may operate under the control of software loaded in memory 116. Network interface 120 connects server 102, 106, or client computing device 108 to network 110. Network interface 120 may support domain-specific networking protocols for various devices. I/O interface 122 connects server 102, 106, or client computing device 108 to one or more storage devices (e.g. storage 104) and peripherals such as keyboards, mice, pointing devices, USB devices, disc drives, display devices 124, and the like.

In some embodiments, I/O interface 122 may facilitate connections with various sensors and other specialized hardware and software used in connection with client devices 108 to processor 114 and/or to other computing devices 102, 106, 108. In some embodiments, I/O interface 122 may be compatible with protocols such as WiFi (e.g., IEEE 802.11a/b/n/ac/ax), Bluetooth, and other communication protocols.

Software may be loaded onto server 102, 106, or client computing device 108 from peripheral devices or from network 110. Such software may be executed using CPU 114 and/or GPU 1140. It will be appreciated that many processing libraries and instruction sets are available for processing using GPUs (e.g. OpenCL, Vulkan, and the like). Thus, in some embodiments the processing libraries for processing image data using GPUs may be used without the need for developers to code new functions or subroutines to perform certain tasks.

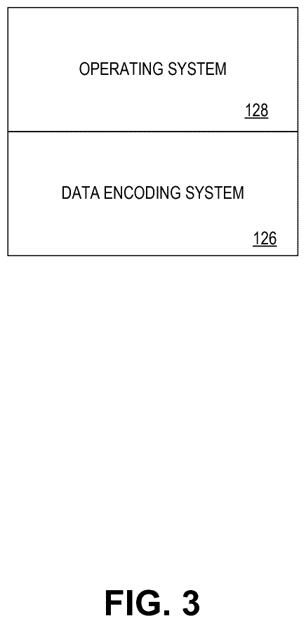

FIG. 3 depicts a simplified arrangement of software at a server 102 or client computing device 108. The software may include an operating system 128 and application software, such as data encoding system 126. In some embodiments, encoding system 126 is configured to interface with, for example, one or more systems or subsystems of server 102, and client devices 108 to send commands to request access to and/or receive data from storage. In some embodiments, encoding system 126 is further configured to receive commands from server 102 and/or client devices 108 to perform certain processing tasks, as described herein.

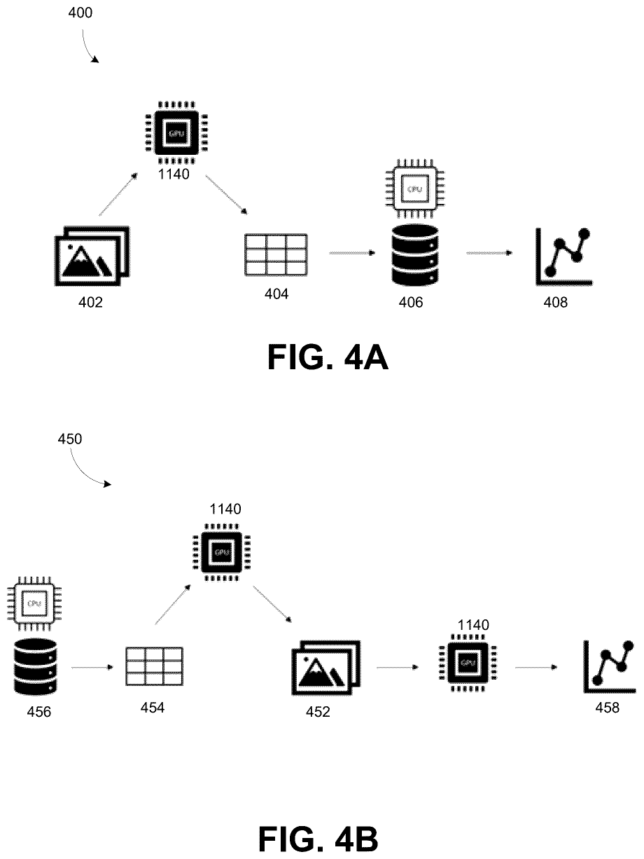

FIG. 4A is a flow diagram depicting a conventional processing paradigm 400. As depicted, GPUs 1140 are typically used to convert image data 402 to structured data 404 (e.g. a data table or array). A database 406 powered by a CPU 114 then performs data analytics 408 on the structured data 404. Such data analytics may be performed using, for example, SQL queries, which are difficult or may not be possible to parallelize. Likewise, certain GPU-powered database designs are limited to SQL queries which cannot be parallelized.

FIG. 4B is a flow diagram depicting a novel processing paradigm 450, in accordance with some embodiments. As depicted, structured data records 454 are retrieved by system 100 from a CPU-powered database 456 and transformed by a GPU 1140 to structured image data records 452. One or more GPUs 1140 may then perform data analytics 458 on image data records 452. In some embodiments, the processing paradigm 450 may result in significant improvements in processing efficiency, time and cost relative to CPU-centric processing for certain processing tasks. For example, a GPU architecture (such as an Nvidia H100) may have 640 Tensor cores and 18,432 CUDA cores, which offer significantly greater capabilities for parallel processing than a conventional CPU (which might have, for example 64 cores).

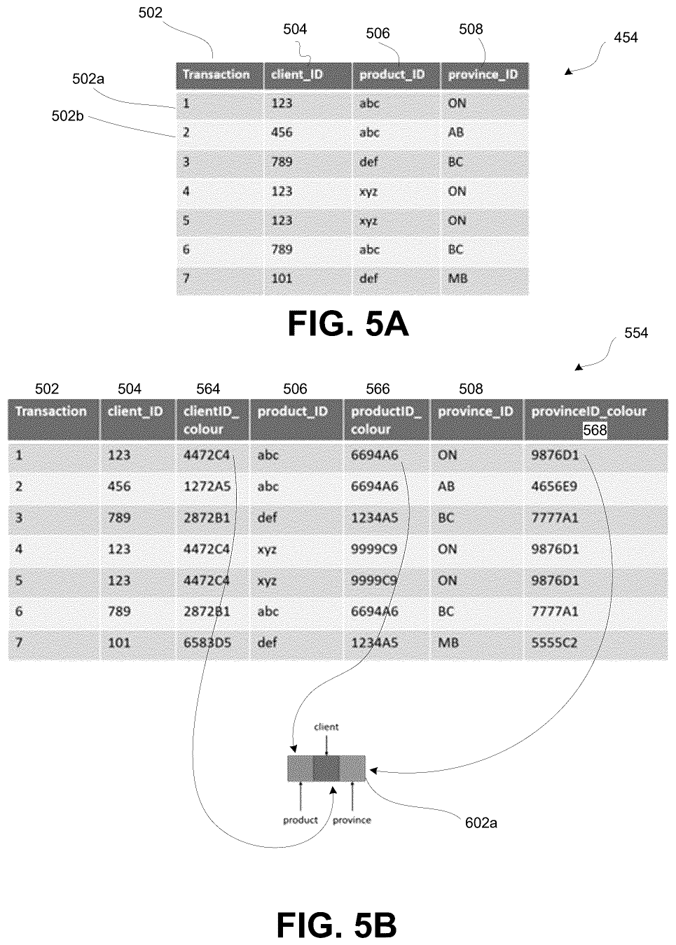

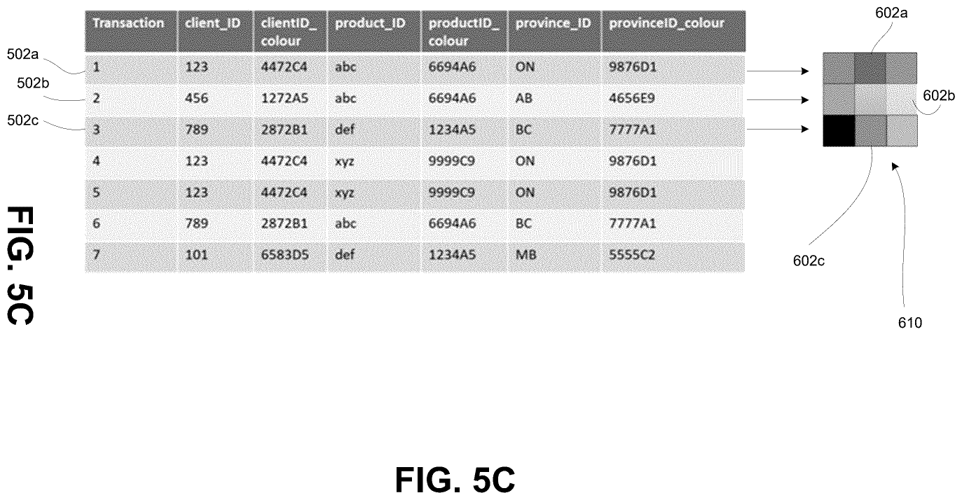

In some embodiments, a structured data record 454 (also referred to herein as a database) may take the form of a business data table, as illustrated in FIG. 5A. It should be appreciated that although the example structured data record depicted in FIG. 5A is transaction records, this is merely an example of a structured data record and that structured data records may relate to a variety of types of data (such as, for example, metadata, electronic health records, product catalogs, search engine optimization tags, security/access logs for digital systems, and the like). As depicted, structured data record 454 may include a plurality of data entries (such as transaction records 502). In some embodiments, each transaction record 502a, 502b, may comprise one or more attributes, such as a client identifier 504, a product identifier 506, and a territorial identifier 508 (depicted as a province_ID in FIG. 5A, although it will be appreciated that other forms of territorial divisions such as counties, states, regions, countries, continents, markets, and the like are contemplated).

As depicted in FIG. 5A, the example data record 454 includes 4 distinct values for the client identifier 504 attribute (e.g., 123, 456, 789, and 101). The example data record further includes 3 distinct values for the product identifier attribute (e.g., abc, def, and xyz). The example data record further includes 4 distinct values for the territorial identifier 508 attribute (e.g., ON, AB, BC, and MB). It should be appreciated that the data record 454 is merely an example and any number of potential values are possible for each attribute, and many other attributes not depicted in FIG. 5A may be included (e.g. agent identifiers, dates, locations, and the like).

In some embodiments, data records 454 may include thousands, millions, billions or more data entries. Moreover, it is common for a plurality of separate, distinct or disparate databases to be maintained by an entity. For example, if an organization has 4 different branch locations, it is common for each branch location to maintain its own database of business activity which does not include activity data from other branches. This may be illustrated, for example, by the system in FIG. 1, in which a database storing data for a first branch location is stored at storage 104, and a separate database for a second branch location may be stored at storage 104b. This may be useful in, for example, reducing the amount of data storage and processing power required locally at each individual branch location to conduct business. Although such separate databases may eventually be uploaded and stored in a central physical location, this configuration nevertheless introduces complexity and difficulty when attempting to analyze records for the organization as a whole, which may require combining records form separate disparate databases, as will be described further below.

Returning to FIG. 5A, a common data analytics task for an organization might be to determine a count of the number of unique costumers the organization has. Although seemingly simple from a conceptual standpoint, this type of computation may nevertheless require a significant, computationally-intensive database query to determine the answer. For example, in the case of example database 454, determining the number of unique customers would be performed by analyzing each transaction, incrementing a count variable each time a unique customer identifier is encountered, maintaining a list of customer identifiers already encountered and accounted for in the count, and determining whether the client identifier 502 value in each subsequent structured data record is present in the list of known customer identifiers that have already been counted, and, and if not, incrementing the count variable by one, and adding the customer identifier to the list of encountered customer identifiers.

Moreover, when an organization maintains separate databases for subsets of data (e.g. a separate database for each branch location), determining the number of unique customers would require combing through each record of each separate database, and there is no quick or computationally simple way to combine separate databases of structured data. One possible approach would be to create a unified database which combines all of the data entries from each of the separate databases into one database, but this could entail billions of data entries and significant volumes of data being transferred from one location to another and manipulated and/or conditioned in various ways prior to even beginning to perform any of the counting data analytics.

As the dimensionality of the data increases, the computational complexity of database operations may increase significantly. A further example processing task might be to determine a count of the number of distinct customers there are for each product an organization sells. For example, in the database depicted in FIG. 5A, product abc has 3 distinct clients (123, 456, and 789), product def has 2 distinct clients (789 and 101) and product xyz has 1 distinct client (123). the computational complexity of making such determinations for databases having billions of records, or the combination of multiple distinct databases each having a substantial number of records, would require significant computational processing commitments. Moreover, the time required to perform such computations may be impractical, and data may be out of sync as new transactions and corresponding transaction records are created at local databases.

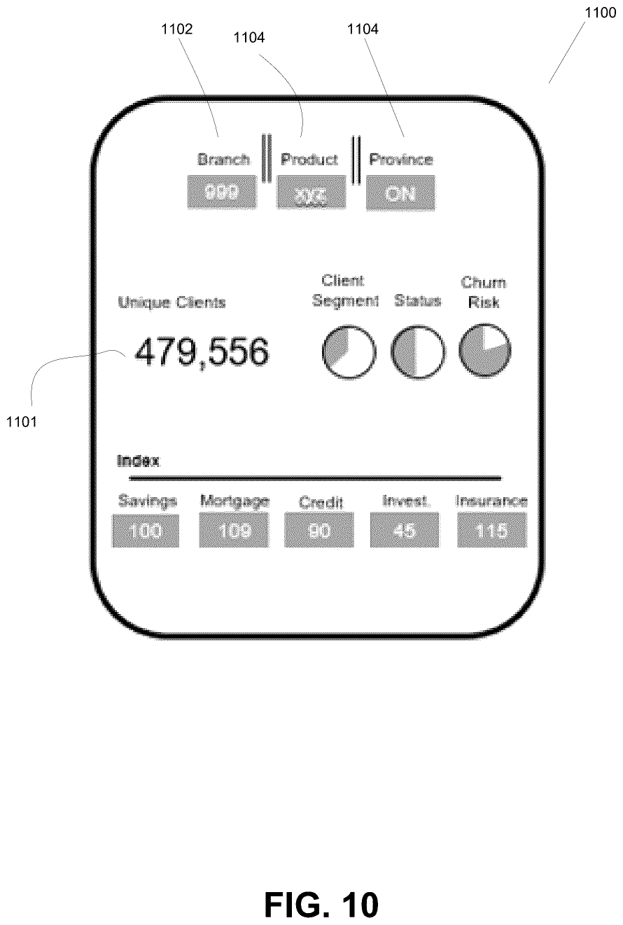

In some embodiments, a client device 108 may display a dashboard application 1100 which allows users to view data analytics, such as a unique client count 1101 (an example user interface of a dashboard is depicted in FIG. 10). As depicted, a dashboard 1100 may allow for quick displaying and switching between various metrics (e.g. branch/location-specific data 1102, product-specific data, location-specific data, and the like). It would be difficult, and of limited practical utility, to provide such a dashboard 1100 or user interface in a client computing device 108 if the required computations to execute a query required significant time and processing power (whether performed locally at a client device 108 or off-loaded to a remote device with increased computing power). Moreover, typical data sets include significantly more records with higher dimensionality and cardinality than the example database provided in FIG. 5A.

For example, an example structured database might include 600 possible product categories, 1000 different store/branch locations, 13 provinces (and/or 50 states), 4 possible customer segments, 2 possible states for whether a customer has or does not have children, and 3 possible customer status values. Using just the aforementioned example dimensions and cardinalities, there exist over 187 million possible permutations and combinations of data (of which different combinations/permutations would be required to perform a particular count operation).

It would be beneficial and practically useful to perform such computational tasks in a more efficient and less computationally-expensive manner. In some embodiments, it may be possible to perform the above-noted tasks in a significantly more efficient manner by using GPU-powered computing rather than CPU-powered computing.

FIG. 5B depicts a transformed data record 554 in which a colour 564, 566, 568 is assigned to each attribute 504, 506, 508. In some embodiments, each client identifier 504 value may be converted to a client identifier colour 564 value. In some embodiments, each product identifier 506 value may be converted to a product identifier colour value 566. In some embodiments, each territorial identifier 508 value may be converted to a territorial identifier colour value 568. In some embodiments, a unique colour value may be assigned for each unique attribute value.

It will be appreciated that the mapping of a string or floating point value to a colour value is a trivial and not computationally-expensive process in modern database systems. An example conversion process is described herein, although it will be appreciated that numerous other ways of conversion processes are contemplated. In an example embodiment, a hash function (e.g., the MD5 message-digest algorithm) may be used on a string or floating point value to obtain a hexadecimal string. In some embodiments, the hexadecimal string may be 24-bit. In still other embodiments, the hexadecimal string may be 30-bit. The hexadecimal string (or a subset of the hexadecimal string) may then be mapped to a corresponding colour in a hexadecimal colour palette. For example, in some embodiments, HTML colour codes may be used as hexadecimal triplets to represent RGB (red, green, blue) colour combinations. In some embodiments, the format for representing an RGB colour may be #RRGGBB for a 24-bit colour palette. For example, the color red may be represented as #FF0000 (i.e., a maximum 255 intensity value for the colour red, and 0 intensities for green and blue). Thus, by varying each of the RGB values, a 24-bit colour palette may be able to represent 16.7 million unique colours, and each unique hexadecimal hash value may be mapped to a unique colour.

It will be appreciated that other types of color mapping strategies are contemplated, and that many different strategies may be appropriate, provided a 1:1 mapping is maintained (such that a unique input will correspond to a unique output colour, and that the same input will be mapped to the same color each time it is mapped). In still other embodiments, 1:1 mappings between values and colours may be achieved without manipulation of data. For example, recognizing that the number of distinct floating point values per column in a data set cannot exceed the number of records in the data set itself, it may be possible to map each unique value to a colour in a colour palette without manipulation. Moreover, in some embodiments, each column may be mapped to a specific pixel location within a sprite/pixel array 710, which may may allow for the same colour to be used for different values appearing in different columns (which would result in the same colour appearing in different pixel locations within a sprite/pixel array 710, as described below). In this manner, the main limitation to the number of values which may be expressed as colours is the number of colours in the colour palette itself (which, as noted below, can be as high as 281 trillion distinct colours).

In database systems today, a table of clients may exist with one row per client. A colour value may be assigned to each client (e.g. client1=colour1, client2=colour2, client3=colour3 . . . clientN=colourN, and so on). This 1:1 assignment is not computationally expensive. In some embodiments, the colour value may be assigned sequentially.

In another example embodiment, a table of transactions may also exist in the database, with a client identifier attached to each row, and the same client information may appear more than once in the transaction table (as a client can have one or more transactions). Joining the client table to the transaction table may be performed by using the client identifier common to both tables. In such an example, the client table may act as a lookup table. Referencing a lookup table in a join operation is not a computationally expensive operation because the client identifier is indexed. As part of this join/lookup operation, the colour ID may be added to the transaction table. In some embodiments, this process may be repeated for other dimensions requiring colour coding (e.g. product identifiers, location identifiers, and the like), and all reference/lookup tables would have a colour identifier added to them.

Advantageously, as noted above, colour palettes in modern computing systems are typically represented as hexadecimal value. Thus, a 24-bit colour palette has 16.7 million possible colours, and a 30-bit colour palette has about 1.07 billion different possible colour values. In still other embodiments, it is contemplated that 36-bit colour palettes (with approximately 69 billion possible colours) and 48-bit colour palettes (with approximately 281 trillion possible colours) may be used. Thus, the conversion of unique data attribute values to unique colours is unlikely to be constrained by the amount of unique possible colours available in a given colour palette.

In some embodiments, certain ranges or subsets of colours may be reserved for specific types of attributes. For example, a certain range of hexadecimal values might be reserved for client identifier colour values, and a certain range of hexadecimal values might be reserved for product identifier colour values. In other embodiments, the colours used for a particular attribute might not be limited to a particular sub-range or subset.

Once colours have been assigned for each attribute value, each data record may be represented as a data structure including a pixel or an array of pixels each having their assigned colour value. For example, data record 502a may be depicted as a 3×1 array of pixels (also referred to herein as a “sprite” 602). As depicted in FIG. 5B, sprite 602a includes a colour in the leftmost pixel corresponding to the product identifier value, a colour in the middle pixel corresponding to the client identifier value, and a colour in the right-most pixel corresponding to the territorial identifier value. It should be appreciated that the aforementioned order of pixels is merely an example embodiment and that pixels can be arranged to depict attributes in a different order than that which is depicted in FIG. 5B.

It should be appreciated that the dimensions of a pixel array or sprite 602, 610 depicted herein are merely examples. For example, a pixel array need not be limited to a square shape, or a rectangular shape, and any sprite shape may be used, and any number of pixels may be used.

As depicted in FIG. 5C, multiple data records 502a, 502b, 502c may be converted to a two-dimensional array of pixels 610 (e.g. sprites 602a, 602b and 602c). It will be appreciated that pixels and/or sprites 602 may be generated for one, some, or all data records in database 454. Moreover, it should be appreciated that data structure 554 is presented for the purposes of illustrating how colours 564, 566, 568 correspond to attributes 504, 506, 508, and that transformed data record 554 would not necessarily be stored as a separate database. It is possible that transformed data record 554 could be stored as a separate database. It is also contemplated that in some embodiments, the transformation of data records 502a, 502b to a plurality of sprites 602 may be performed without duplicating and storing an additional copy of data record 454. Moreover, a data record 502a can be represented in a number of different ways, depending on the nature of the database query being made.

For example, if the database query relates only to one attribute of each data record (e.g. “return the number of distinct customers” or “return the number of distinct types of products sold”), data encoding system 126 may determine a colour for the client identifier value (or product identifier value) only for each data record and generate a single pixel to represent each data record. If the database query relates to a combination of attributes (e.g. “return the number of distinct customers who purchased a certain product”), the data encoding system 126 may determine a colour for both the client identifier value and the product identifier value and generate a 1×2 pixel sprite for each data record.

In some embodiments, the number of pixels included in a sprite corresponding to a data record may be independent from the number of attributes related to a database query. For example, in some embodiments a pixel may be generated for some or all of each attribute for each data record, irrespective of whether a query has been received relating to a particular attribute(s) of the data records.

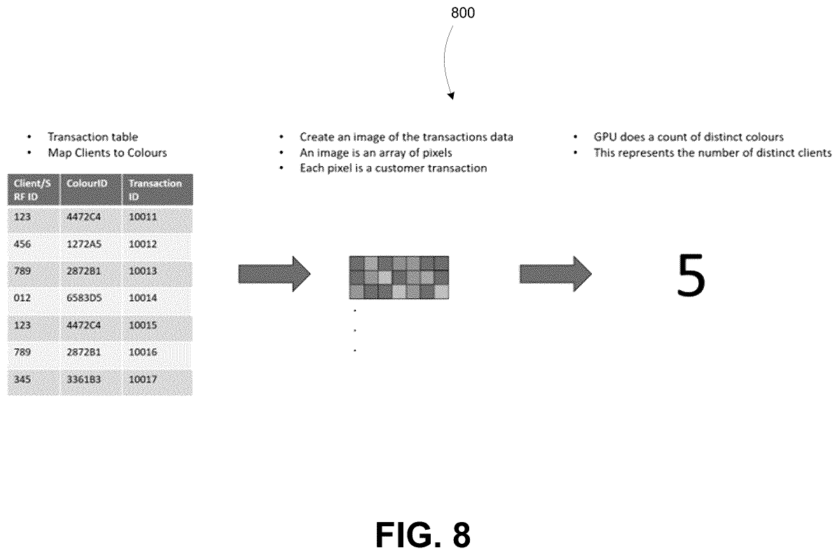

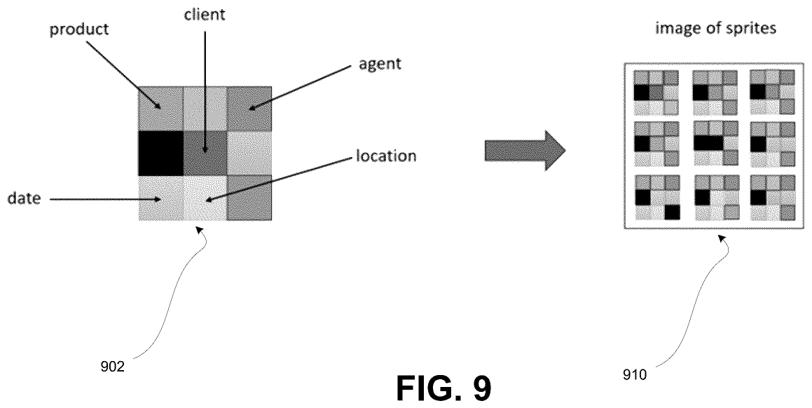

Returning to the above-noted example task of returning the number of distinct clients/customers an organization has, the task becomes relatively straightforward when using the generated image data (e.g. sprite data structure 602). A GPU 1140 can be provided with the sprite data structure 610 and perform an image query to return the number of unique colours in a particular column (in the case of sprite 610 depicted in FIG. 5C), which is a straightforward operation which can be performed much more efficiently by a GPU 1140. In another embodiment, as depicted in FIG. 8, a single pixel may be generated for each database record (corresponding to the value of the “client identifier” attribute, and sent to the GPU 1140, which may perform a simple count of the number of distinct colours in the image map (which corresponds to the number of distinct clients/customers in the database 454).

In some embodiments, even a consumer-grade GPU (e.g. an NVIDIA Geforce RTX 4080 used for gaming) can process or render at least 30 frames per second (sometimes hundreds of frames per second) at the so-called “8K” resolution (e.g. 7680 horizontal×4320 vertical pixels, or ˜33.2 million total pixels per frame). Thus, in an example data set where the data records include a billion pixels (which corresponds to about 30 frames at the 8 k resolution), a consumer-grade Graphics Processing Unit can be expected to process this quantity of data in a fraction of a second. Thus, it is clear that transforming data records may offer significant reductions in processing time and energy, as well as cost, relative to conventional CPU-powered systems which require computationally intensive data traverses to obtain the same result. A person skilled in the art will appreciate that commercial-grade GPUs (e.g., an NVIDIA A100 or H100) can perform graphics processing at orders of magnitudes faster than consumer-grade GPUs, and as such the systems and methods described herein may be capable of handling extremely high volumes of data with relative ease and efficiency relative to CPU-based calculations.

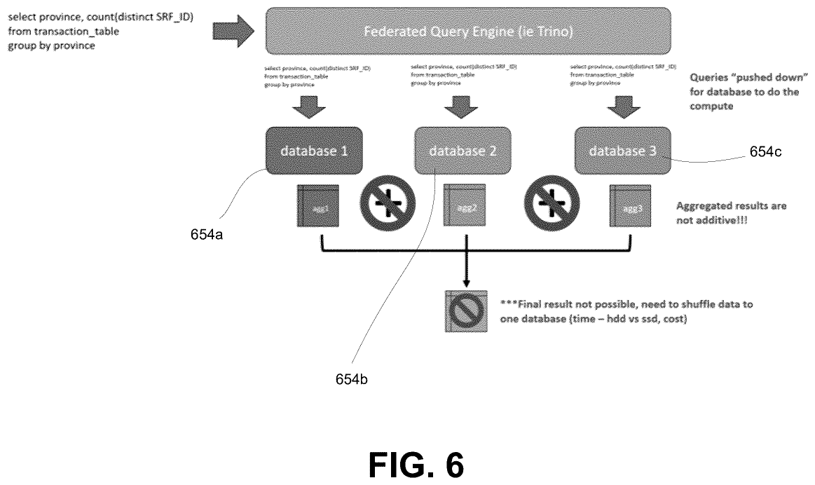

Moreover, in some embodiments, the above-noted issue of combining disparately maintained databases prior to performing data analytics may also be ameliorated or alleviated entirely. For example, as shown in FIG. 6, when a query (e.g. a query to count the number of distinct customers/clients for an organization) is generated, the records from separate databases 654a, 654b, 654c cannot simply be considered separately and added together to arrive at a result (for example, a client identifier might appear to be unique in two separate databases but should not be counted as two unique clients in the overall universe). Therefore, each separate database 654a, 654b, 654c would have to be amalgamated and merged into a new universal database prior to performing data analytics operations using a CPU 114, which is a significant expenditure of computing resources.

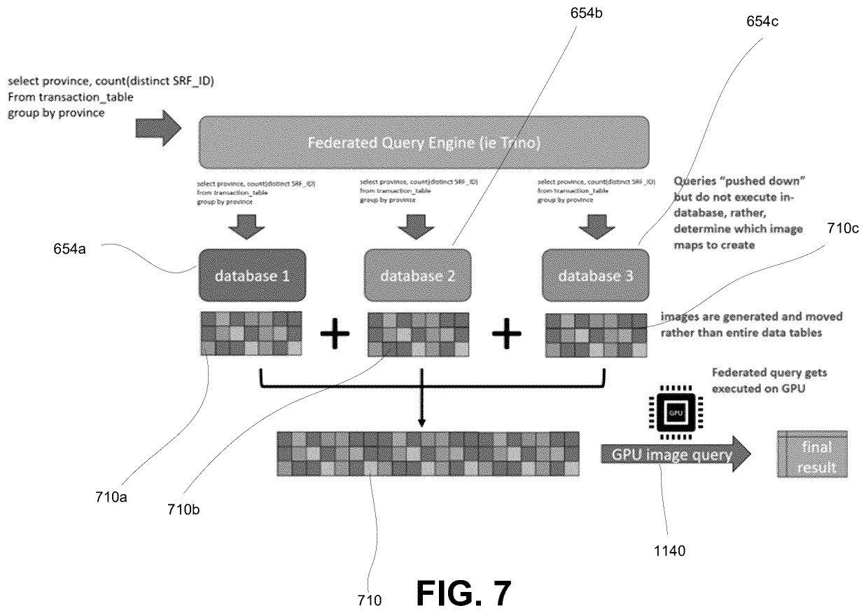

Contrastingly, as shown in FIG. 7, in some embodiments, when a given query is received, each record in database 654a, 654b, 654c may be transformed into a respective pixel/sprite structure 710a, 710b, 710c using embodiments of the methods and processes described herein. Advantageously, these pixel structures 710a, 710b, 710c (which may require far less bandwidth and/or storage than the original databases 654a, 654b, 654c from upon which the pixel structures were based) may then be transmitted to a GPU processing system 1140 which may perform GPU data analytics in significantly less time.

For example, in some embodiments, if a query requests the number of unique clients of an organization, the data records in each database can be converted to a pixel structure 710 (also referred to herein as an image map) which converts only the client identifier attribute values to colours. Thus, when a database's records have high dimensionality/cardinality, in some embodiments, only certain dimensions relevant to a particular query (e.g. client identifier values) would be converted to colours and transmitted as an image map 710 representative of those records, without necessarily having to convert the values of other attributes to colours or include those other attributes in the image map 710. Moreover, existing GPU instruction sets provide the functionality required for data analytics (such as returning a count of the number of distinct colours in an image or series of images), thereby obviating the need to create new code libraries to provide the desired functionality.

Returning to the example dashboard 1100 depicted in FIG. 10, this dashboard may be running on, for example, a client computing device 108. When a user of dashboard 1100 enters a command to dashboard 1100 to display a particular data metric, the dashboard application may generate a command which transmits a query to one or more databases stored in storage 104, 104b. In response to receiving the query, data encoding system 126 may determine which attributes of data records are relevant to the query, and generate image maps (e.g. pixel and/or pixel arrays) for each relevant data entry in the relevant databases. This generated image data may then be transmitted to a computing device having a GPU 1140 which can efficiently analyze the image data and return the desired metric and associated metadata to client device 108 for displaying on dashboard 1100 within a short, practically useful amount of time. In some embodiments, dashboard 1100 and data encoding system 126 may be configured to provide near real-time and/or on-demand data analytics in response to a query from a user.

In some embodiments, metrics may be generated in real-time on a backend server (for example, metrics may be generated when one or more of the databases 654a, 654b, 654c have been updated to include new records). In some embodiments, metrics may be generated on a periodic basis. In some embodiments, metrics may be generated in real-time (e.g., when a user of dashboard 1100 requests a certain metric). It will be appreciated that various design considerations would figure into how often and/or when a database is updated. For example, some systems use day-old data upon which to base metrics, as data records may be constantly changing throughout business hours. Some embodiments described herein may be compatible with any type or schedule of database maintenance.

Likewise, in the case of a metric such as the number of unique customers for a particular product, a GPU can, with relative computational ease, analyze groups of pixels (for example, given the knowledge that a product pixel identifier will be to the immediate left of a client identifier pixel in some embodiments) to determine the number of unique colors which are one pixel adjacent to a pixel of a given colour. In another embodiment, when a sprite or image map is a 3 pixel×3 pixel square, an example query could analyze the colour of the center pixel, and the colour of the top right corner pixel. Alternatively, in embodiments in which a subset of the colour palette is assigned to specific pixel locations in the sprite (as described further below), then a query could be generated to determine how many sprites have a particular first colour (i.e. colour X) and a particular second colour (i.e. colour Y) in them, regardless of pixel location, because it would be known that the colour values in the ranges of each pixel position do not overlap. For example, if the center pixel of the sprite can only be shades of orange and the top right pixel of the sprite can only be shades of blue, a query could determine how many sprites have a particular shade of orange and a particular shade of blue. Advantageously, such a query would not need to specify which pixels to query within the sprite, since the pixel location within the sprite would be irrelevant. Similar algorithms may be used to assess data records having multitudes of dimensionality which would otherwise make CPU-based processing impractical, time-consuming and expensive.

Therefore, in some embodiments, a complex and computationally intensive task in CPU-powered systems may be converted to a streamlined, computationally efficient process for a GPU-powered system. For example, if analyzing 1 billion transaction records to determine the number of unique customers alone, this could be accomplished in very little time by a GPU, without any need for copying substantially large amounts of data from one location to another to consolidate multiple databases, or for converting more data elements than necessary to colours for GPU processing.

Some embodiments may offer enhanced data security relative to conventional data processing methods. For example, if copying database records from one location to another to generate a consolidated universal database, there is a risk of communications being intercepted. Although communications are typically encrypted in some shape or form, there is nevertheless the risk of full data records falling into the possession of bad actors, particularly with the possibility of emerging computing devices (e.g., quantum computers) with the potential to break encryption techniques.

Contrastingly, some embodiments of the systems and methods described herein avoid this risk by transmitting streams of pixel data. Whether encrypted or not, the image maps generated for processing by a GPU 1140 are unlikely to have any meaning beyond the specific count or analytics for which the image maps 710 were generated. As such, some embodiments described herein may offer substantial improvements in data security relative to conventional techniques.

It will be appreciated that by transforming certain types of data structures (e.g., business or transaction data tables) to image data, numerous advantages may result, including but not limited to a) more efficient data movement from databases to GPU memory (as sprites and image maps use significantly less data than transmitting full data records), b) GPU-agnostic processing (as no particular make or brand of GPU is required, since code libraries which are not specific to GPU manufacturers are available for most or all GPU chipsets and models), c) improved data security, d) improved processing efficiency (by obviating the need for encrypting data in transit when the data is meaningless pixel data), e) the ability to leverage existing gaming and graphics engines for 2D/3D sprite processing and more advanced physical-attribute mapping, and f) a significantly more efficient mechanism for performing certain database queries (such as the count-distinct query) than brute force CPU-based solutions.

It will be appreciated that image maps 710 and sprite data structures 602 may have varying dimensionalities, depending on the circumstances. In some embodiments, an image map 710 or sprite data structure 602 may only need to be a single pixel for each data record 502. In some embodiments, an image map 710 or sprite data structure may be a one-dimensional array (e.g. sprite 602a depicted in FIG. 5B). In some embodiments, an image map or sprite data structure 602 may be a two-dimensional pixel array (as depicted, for example, by sprite 902 in FIG. 9). Moreover, in some embodiments, two-dimensional sprites 902 may be combined or otherwise appended to create larger image maps 910 for processing by GPU cores. In some embodiments, an image map 710 or sprite data structure 602 may be a 3-dimensional pixel array. In some embodiments, an image map 710 or sprite data structure 602 may have greater than 3 dimensions.

In some embodiments, each sprite data structure 602 of a plurality of sprite data structures has the same dimensions, shape and size. That is, although sprites can be of any shape and/or size, in some embodiments, each sprite 602 can be generated so as to have the same shape, number of pixels, and the like. For example, all sprites in an image might be 3 pixels×3 pixels. In embodiments, in which sprites 602 have uniform shape and size, it may be possible to leverage the use of advanced sprite processing capabilities which are available and in use in the gaming domain. For example, the Unreal Engine is capable of quickly loading sprites by defining the starting point and dimensions of one sprite within an image (a so-called “sprite sheet”), which allows the Engine to perform the required offset calculates to extract some or all of the other sprites 602 within the sprite sheet.

Some embodiments of the systems and methods described herein may offer significant advantages over conventional CPU-powered processing techniques. For example, very large volumes of data can be represented in a relatively compact form of a small number of images or frames. Moreover, the image data can be transmitted to a cloud server with relatively little bandwidth, and if hacked or stolen, the image data is essentially meaningless to a third party. Some embodiments may benefit from the fact that image data is already the format of data which GPUs are specifically tailored to process, and that GPUs (which are normally used to render image frames for video games or movie/television data) can process massive amounts of image data with extreme efficiency. Moreover, some embodiments described herein are GPU agnostic, and therefore do not rely on the use of a particular make or brand of GPU, nor on a particular instruction set for a particular make or brand of GPU.

In some embodiments, the use of image-based processing may allow for further beneficial functionality stemming from existing code libraries and video processing engines. For example, the Unreal Engine, which is used in the video game industry, offers a simulated real-world physics engine. Thus, it is possible to leverage this existing functionality already available in video processing engines to provide additional attributes to sprites and/or images maps beyond image-based attributes. In some embodiments, three-dimensional sprites may have additional attributes which may be represented in a three-dimensional environment.

For example, a sprite may have additional attributes such as buoyancy, magnetism, luminosity, gravity, reflectiveness, and the like, which are natively supported by existing video processing engines, such as the Unreal Engine. The availability of such additional physical attributes for use with 2D and 3D sprites may facilitate deeper analysis and meanings for data records which might not be apparent in their native data record form. Advantageously, such functionality is already available to the developer community and can be leveraged for use in novel contexts (e.g. business or transaction records) without having to create new code libraries or functions. For example, certain data records which display high buoyancy may have traits in common, which may be useful in conducting machine-learning and artificial intelligence techniques to identify deeper meanings within data records.

Of course, the above-described embodiments are intended to be illustrative only and in no way limiting. For example, although examples described herein mainly relate to problems involving counting distinct entities, it will be appreciated that this is merely an example of the types of computing tasks which are normally computationally-intensive on a CPU-based system but which may be made significantly more efficient through data transformations to image maps for GPU processing. It will be appreciated that the applications for the systems and methods described herein is not limited to the analysis of transactional data records and instead can be applied to any structured data with the resulting benefits of the inherent advantages of GPU-based processing relative to CPU-based computing. The described embodiments are susceptible to many modifications of form, arrangement of parts, details, and order of operation. The invention is intended to encompass all such modifications within its scope, as defined by the claims.

What is claimed is:

1. A method of performing Graphics Processing Unit (GPU) based operations on structured data, the method comprising:
accessing at least one database having a plurality of data records, each of said records having a plurality of attributes, each of said attributes having a value;
for each of said data records, determining a respective colour corresponding to a respective value of at least one of said attributes;
generating, for each of said data records, image data comprising at least one pixel having said respective colour corresponding to said at least one of said attributes;
transmitting said image data to a graphics processing unit;
executing a query on said image data using said GPU; and
transmitting a result of said query to a computing device.

2. The method of claim 1, wherein said query relates to a number of said attributes of said data records, and wherein said at least one pixel comprises said number of pixels.

3. The method of claim 1, wherein said image data comprises a single pixel having said colour.

4. The method of claim 1, wherein said image data comprises a one-dimensional array of pixels having said respective colours.

5. The method of claim 1, wherein said image data comprises a two-dimensional array of pixels having said respective colours.

6. The method of claim 1, wherein said at least one database comprises at least a first database and a second database storing at least one data record distinct from said data records of said first database.

7. The method of claim 6, wherein generating said image data comprises generating said image data for each of said data records of said first database and said second database and transmitting said image data to said graphics processing unit.

8. The method of claim 1, wherein said query is to determine a number of unique values for a particular attribute of said plurality of attributes.

9. The method of claim 8, wherein said data records are transaction records, and wherein said query is to determine a number of distinct customers included in said data records.

10. The method of claim 1, wherein said colours are selected from a 24-bit colour palette.

11. The method of claim 1, wherein said colours are selected from one of a 30-bit colour palette, an 36-bit colour palette, and a 48-bit colour palette.

12. The method of claim 1, wherein said colours for said values of an individual attributes are selected from a subset of a colour palette.

13. The method of claim 1, further comprising:
receiving, prior to said determining, a query for said at least one database; and
transforming said query for said at least one database into an image query for execution by said GPU.

14. A system for performing Graphics Processing Unit (GPU) based operations on structured data, the system comprising:
one or more processors;
one or more GPUs;
one or more non-transitory computer-readable storage media having stored thereon computer-executable instructions that, when executed by the one or more processors, cause the one or more processors to:
access at least one database having a plurality of data records, each of said records having a plurality of attributes, each of said attributes having a value;
for each of said data records, determine a respective colour corresponding to a respective value of at least one of said attributes;
generate, for each of said data records, image data comprising at least one pixel having said respective colour corresponding to said at least one of said attributes;
transmitting said image data to one or more of said GPUs;
executing a query on said image data using said one or more GPUs;
transmitting a result of said query to a computing device.

15. The system of claim 14, wherein said query relates to a number of said attributes of said data records, and wherein said at least one pixel comprises said number of pixels.

16. The system of claim 14, wherein said image data comprises a single pixel having said colour.

17. The system of claim 14, wherein said image data comprises a one-dimensional array of pixels having said respective colours.

18. The system of claim 14, wherein said image data comprises a two-dimensional array of pixels having said respective colours.

19. The system of claim 14, wherein said at least one database comprises at least a first database and a second database storing at least one data record distinct from said data records of said first database.

20. The system of claim 19, wherein generating said image data comprises generating said image data for each of said data records of said first database and said second database and transmitting said image data to said GPU.
